(19) United States
(12) Patent Application Publication
(10) Pub. No.: US 2008/0316177 A1
(43) Pub. Date: Dec. 25, 2008

(54) Mouse-type mobile phone

(76) Inventor: Kuo-Hwa Tseng, Taoyuan (TW)

Correspondence Address: TROXELL LAW OFFICE PLLC, Suite 1404, 5205 Leesburg Pike, Falls Church, VA, 22041, US

(21) Appl. No.: 11/812,979

(22) Filed: Jun. 22, 2007

(51) Int. Cl. G06F 3/02

(52) U.S. Cl. 345/168

(57) ABSTRACT

A mouse-type mobile phone comprises a phone body and an upper lid, wherein the phone body has a battery cover on the backside, an optical reading device on one side of the battery cover and a push cover mounted above the optical reading device. The push cover is a power switch to enable or disable the mouse function. Several mouse clicks and a scroll wheel are mounted on one side of the display monitor of the upper lid. A chip module structure comprises a message transmission interface, a central processing unit and a human-based interface and apparatus, wherein the phone body can be wirelessly or wiredly coupled with a computer via the message transmission interface. The human-based interface and apparatus has a mouse device unit and several mouse clicks coupled with the central processing unit so that a control signal can be transmitted to the computer.

### FIELD OF THE INVENTION

The present invention relates to a mouse-type mobile phone, and more particularly to a mobile phone with mouse function so that it can be immediately charged and utilized to transmit data and reduce required phone accessories.

### BACKGROUND OF THE INVENTION

The modern people have close relation with mobile phones and computers either in work or life. The general consumers usually hold the mobile phone directly or use the wired or Bluetooth earphone. However, the utilization of mobile phone may have the following problems:

1. during the communication mode: The mobile phone or the Bluetooth earphone may run out of stored electric energy, and the wired earphone's wire may get tied, which delay the other party.

2. during the charge mode: The mobile phone may be only half charged or the user may forget to carry the backup battery or the battery charger. In addition, the frequent replacement of the batteries causes the pins of some mobile phones where the outer covers are integrated with the batteries to be broken easily. As a result, it results in the poor contactness during the charge mode.

Those described above are frequently occurred conditions or the phone accessories needed to be carried out by the user.

However, with the popularization of computer, the computer brings more and more convenience to work, study and even the general family. Because the notebook computer has powerful working performance and it is portable, everyone is very fond of computer. However, the following conditions occur when the user uses either of the desktop computer and the notebook computer.

1. communication by mobile phone: If there is a phone call when the user uses the computer, the user must put down the mouse or use the earphone to answer the phone call.

2. outdoor use: For the purpose of outdoor use, the computer peripherals and phone accessories including the notebook computer charger, exterior mouse, mobile phone charger, second backup battery, USB connection wire (card reader, digital camera, mobile phone) must be carried.

At present, none of the known mobile phone is equipped with mouse function so the consumer must stop the work in hand to answer the phone call even if this consumer is busy with operating the computer. Therefore, there is a need to provide an improved mobile phone with mouse function.

### SUMMARY OF THE INVENTION

It is an object of the present invention to provide a mobile phone with mouse function so that it can be utilized for multiplex transmission to transmit data. After connection with the computer, the mouse-type mobile phone provides multiplex transmission, and its functions of charge, mouse, data transmission, and phone can coexist without mutual influence.

The characteristics of the present invention are listed as follows:

1. ready charge: After connecting the mobile phone with the computer, the mobile phone is in the charge mode so that it has saturated electric power all the time and has the phone function simultaneously.

2. lightened carriage: When the notebook computer is carried out for outdoor use, the common-use interface or Bluetooth interface can be utilized to drive the mouse function directly so that the required computer peripherals and phone accessories can be relatively reduced.

3. multiplex transmission: After connection with the computer, the mouse-type mobile phone provides multiplex transmission, and its functions of charge, mouse, data transmission, and phone can coexist without mutual influence.

4. simple and easy illumination: When the red LED of the optical reading device is lighted up, it can provide a small range of illumination by means of its trace luminosity.

The appearance of the mouse-type mobile phone has the following features:

1. Mouse Clicks and Optical Reading Apparatus:

The general optical mouse has two mouse clicks on both left and right sides and a scroll wheel. In addition, the general optical mouse has ebonite pads and an optical reading device on the bottom. These devices are all integrated into the mobile phone. In addition, a push cover is additionally mounted above the optical reading device to protect cleanliness of the optical reading device. The push cover is a power switch to enable the mouse function, thereby saving energy.

2. Universal Serial Bus:

The mobile phone has a USB port on the top edge near an antenna so as to provide easy connection with the computer at any time without changing the usual habit. As a result, it can be operated as the general mouse so that the data of the memory card of the mobile phone can be transmitted outwardly.

3. The Eeight of the Mouse-Type Mobile Phone:

The current commercial mobile phone including its battery has a weight of 80 g-120 g. It is heavier than, but close to, the general mouse. Therefore, its weight has no influence on the operation.

Furthermore, the cost increased by integrating the mouse function with the chip and module of the mobile phone does not exceed one US dollar. In addition, it provides the substantial benefit to integrate the mobile phone with the computer at a later date.

### BRIEF DESCRIPTION OF THE DRAWINGS

FIG. 1 is an elevational view showing the mouse-type mobile phone of the present invention;

FIG. 2 is an elevational view showing the front side of the mouse-type mobile phone of the present invention;

FIG. 3 is an elevational view showing the back side of the mouse-type mobile phone of the present invention;

FIG. 4 is an elevational view showing the mouse-type mobile phone in accordance with another preferred embodiment of the present invention; and

FIG. 5 is a circuitry block diagram of the mouse-type mobile phone of the present invention.

### DETAILED DESCRIPTION OF THE PREFERRED EMBODIMENT

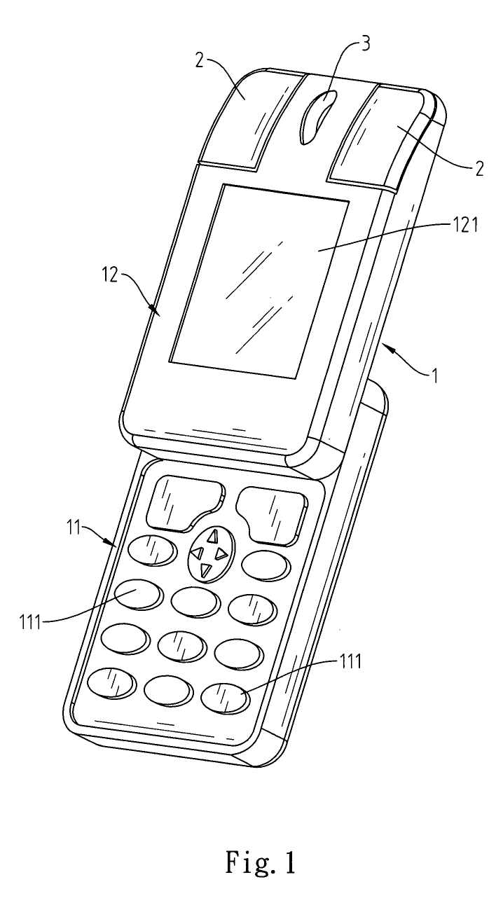

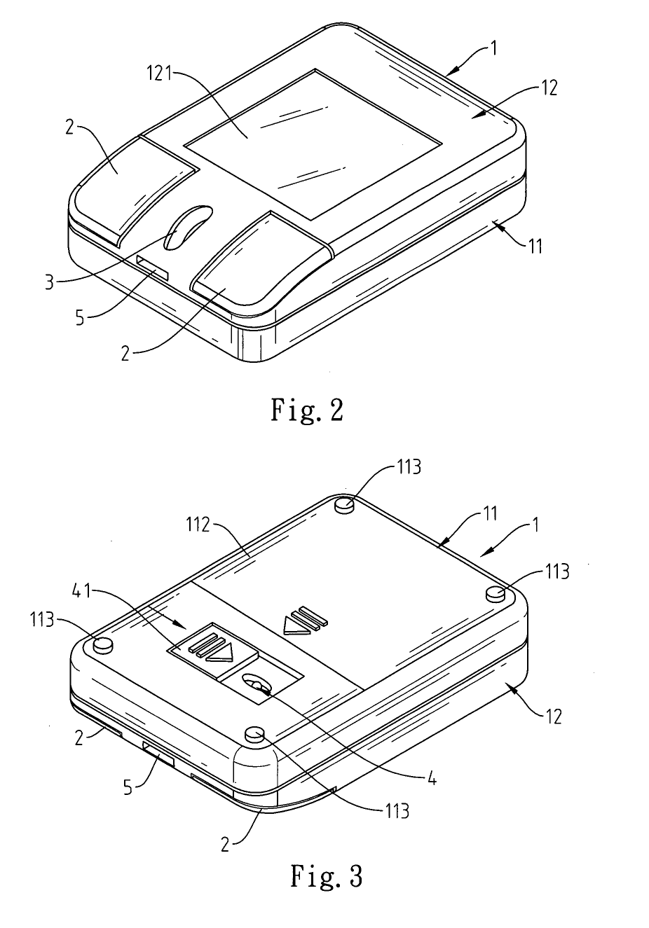

Referring to FIGS. 1 through 3, a mouse-type mobile phone of the present invention is shown, wherein the mobile phone has both functions of optical mouse and mobile phone. There is no difficulty to purely integrate the mouse function into the inside of the mobile phone by means of the present electronic technology, wherein there is only a need to reserve the positions for the mouse clicks and the optical reading head on the outside of the plastic-ejection mold.

The mouse-type mobile phone 1 generally comprises a phone body 11 and an upper lid 12, wherein the upper lid 12 is slidable or liftable to open position. The upper surface of the phone body 11 has a keyboard interface 111 mounted thereon. Four pads 113 are mounted on four corners of the backside of the phone body 11, respectively. In addition, a battery cover 112 is mounted on the backside of the phone body 11, and an optical reading device 4 is mounted on one side of the battery cover 112. In addition, a push cover 41 is mounted above the optical reading device 4. The push cover 41 is a power switch to enable or disable the mouse function and also provides the dustproof function to protect cleanliness of the optical reading device 4. In addition, the upper lid 12 has a display monitor 121 on the surface, and two mouse clicks 2 and a scroll wheel 3 are mounted on one side of the display monitor 121. Besides, a universal serial bus (USB) port 5 is mounted on the edge of the phone body 11. The USB port 5 is a multiplex transmission interface for the interior.

The USB port 5 provides easy connection with the computer at any time without changing the usual habit. As a result, it can be operated as the general mouse.

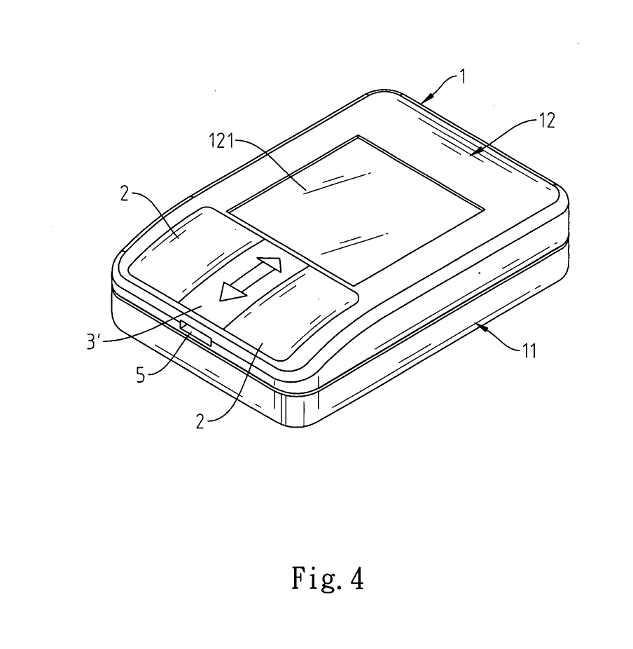

Referring to FIG. 4, another preferred embodiment of the present invention is shown. In this preferred embodiment, a touch plate 3′ is mounted on the upper lid 12, and two mouse clicks 2 are mounted respectively on both sides of the touch plate 3′ so as to shift the cursor shown on the display monitor and to further scroll up or down the page by gently touching the touch plate 3′.

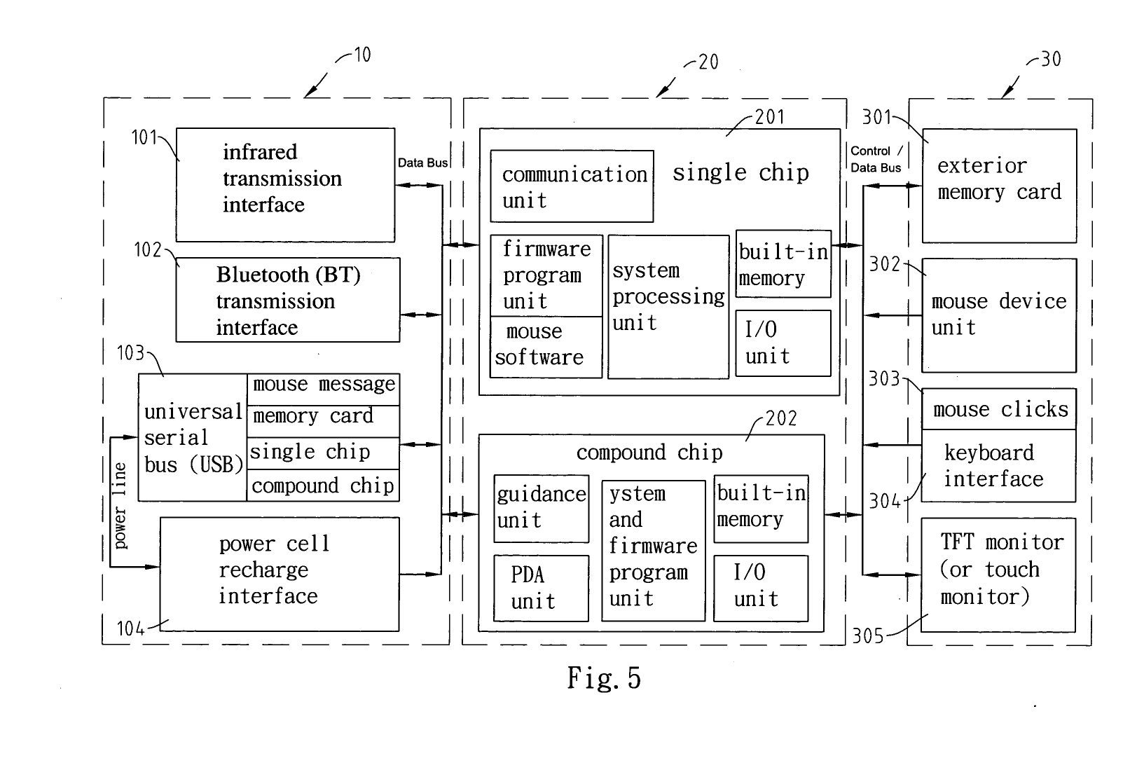

Referring to FIG. 3 and FIG. 5, a control circuit of the mouse-type mobile phone of the present invention is shown. In this control circuit, the mouse function is added into the chip and the module. The control circuit comprises a message transmission interface 10, a central processing unit 20 and a human-based interface and apparatus 30.

The message transmission interface 10 is able to upload and download signal. The message transmission interface 10 is such as an infrared transmission interface 101, a Bluetooth (BT) transmission interface 102, a universal serial bus (USB) interface 103 and a power cell recharge interface 104. The USB interface 103 and the power cell recharge interface 104 can be connected to each other by a power line for signal transmission or charge. The USB interface 103 can be connected to a mouse message, a memory card, a single chip, a compound chip for multiplex message transmission.

The human-based interface and apparatus 30 comprises an exterior memory card 301, a mouse device unit 302 (such as a scroll wheel and an optical reading device), mouse clicks 303, a keyboard interface 304, and a display monitor 305, wherein the human-based interface and apparatus 30 is designed to transmit a control signal to the central processing unit 20 so that the central processing unit 20 can process the received control signal.

The central processing unit 20 comprises a single chip circuit 201 and a compound chip circuit 202, wherein the single chip circuit 201 comprises a system processing unit, a communication unit, a firmware program unit, a mouse software, a built-in memory and an I/O unit. The compound chip circuit 202 comprises a system and firmware program unit, a guidance unit, a PDA unit, a built-in memory and an I/O unit. The mouse device unit 302 and the mouse clicks 303 are coupled with the central processing unit 20 so that the control signal generated by wheel rolling of the mouse device unit 302, positioning of the LED optical reading device or pressing of the mouse clicks can be transmitted to the computer via the message transmission interface 10. The message transmission interface 10 provides wireless transmission mode or wired transmission mode.

In accordance with the mouse-type mobile phone 1 of the present invention, both functions of optical mouse and mobile phone can be utilized simultaneously. The mouse-type mobile phone provides multiplex transmission, and the functions of charge, mouse, data transmission, and phone can coexist without mutual influence. The optical reading device 4 is mounted on one side of the battery cover 112 of the phone body 11. In addition, the push cover 41 is mounted above the optical reading device 4 to enable or disable the power of the mouse function. The mouse function can be disabled by merely using the push cover 41.

What the invention claimed is:

1. A mouse-type mobile phone, comprising:
an upper lid having a display monitor on the surface;
a phone body having a keyboard interface on the upper surface, four pads on four corners of the backside, a battery cover on the backside, an optical reading device on one side of said battery cover, a push cover mounted above said optical reading device, and a plurality of mouse clicks and a scroll wheel mounted on one side of said display monitor of said upper lid, said push cover being a power switch to enable or disable the mouse function; and
a chip module structure comprising a message transmission interface, a central processing unit and a human-based interface and apparatus, wherein said phone body can be wirelessly or wiredly coupled with a computer via said message transmission interface, said human-based interface and apparatus has a mouse device unit and said mouse clicks coupled with said central processing unit so that a control signal generated by wheel rolling of said mouse device unit or pressing of said mouse clicks can be transmitted to said computer.

2. A mouse-type mobile phone according to claim 1, wherein said phone body further has at least one universal serial bus (USB) port on the edge.

3. A mouse-type mobile phone according to claim 1, wherein said mouse clicks and a touch plate are mounted on one side of said display monitor of said upper lid of said phone body.

4. A mouse-type mobile phone according to claim 1, wherein said message transmission interface comprises an infrared transmission interface, a Bluetooth (BT) transmission interface, a universal serial bus (USB) interface and a power cell recharge interface, and said USB interface and said power cell recharge interface can be connected to each other by a power line for signal transmission or charge.

5. A mouse-type mobile phone according to claim 1, wherein said USB interface can be connected to a mouse message, a memory card, a single chip, a compound chip for multiplex message transmission.

6. A mouse-type mobile phone according to claim 1, wherein said human-based interface and apparatus comprises an exterior memory card, a mouse device unit, said mouse clicks, said keyboard interface, and said display monitor.

7. A mouse-type mobile phone according to claim 1, wherein said central processing unit comprises a single chip circuit and a compound chip circuit, said single chip circuit comprises a system processing unit, a communication unit, a firmware program unit, a mouse software, a built-in memory and an I/O unit, and said compound chip circuit comprises a system and firmware program unit, a guidance unit, a PDA unit, a built-in memory and an I/O unit.
